(19) United States
(12) Patent Application Publication
(10) Pub. No.: US 2016/0108791 A1
(43) Pub. Date: Apr. 21, 2016

(54) Aftertreatment Control for Detection of Fuel Contaminant Concentration

(71) Applicant: Caterpillar Inc., Peoria, IL (US)

(72) Inventors: Sylvain J. Charbonnel, Peoria, IL (US); Brian V. Tranel, Peoria, IL (US); Purvarag S. Shah, Dulap, IL (US)

(73) Assignee: Caterpillar Inc., Peoria, IL (US)

(21) Appl. No.: 14/516,351

(22) Filed: Oct. 16, 2014

(51) Int. Cl. F01N 11/00; G01M 15/10

(52) U.S. Cl. CPC F01N 11/007; G01M 15/102; F01N 2550/02

(57) ABSTRACT

A method and a system for determining if fuel containing more than the desired concentration of sulfur is being combusted in an engine. The engine includes a selected catalytic reduction (SCR) module or a lean NOx trap (LNT) and the system includes various sensors and a controller for calculating NOx conversion ratio and ammonia slip. Timers are utilized for purposes of positively identifying when sulfur in the fuel is causing a substandard performance of the exhaust system. If the timers or time periods are not satisfied, a conversion ratio failure or an ammonia slip failure is attributable to equipment failure, and not sulfur in the fuel. However, if the timers are satisfied, then sulfur in the fuel is positively identified as the problem thereby enabling the operator to eliminate equipment failure as a possible source of the conversion ratio or ammonia slip failure.

### TECHNICAL FIELD

This document discloses various methods and systems for detecting contaminant concentrations in a fuel. For example, this document discloses methods and systems for detecting sulfur concentrations in a fuel, such as diesel fuel. Still more specifically, this document discloses methods and systems for detecting if a low sulfur diesel (LSD) has been introduced into an engine intended to run on ultra-low sulfur diesel (ULSD).

### BACKGROUND

Power systems for engines, factories, and power plants produce emissions that contain a variety of pollutants. These pollutants may include, for example, particulate matter (e.g., soot), nitrogen oxides (NOx), and sulfur compounds. Due to heightened environmental concerns, engine exhaust emission standards have become increasingly stringent. In order to comply with emission standards, engine manufactures have developed and implemented a variety of exhaust after-treatment components to reduce pollutants in exhaust gas prior to the release of exhaust gas into the atmosphere.

The exhaust after-treatment components may include, for example, a diesel particulate filter (DPF), one or more selective catalytic reduction (SCR) devices, a lean NOx trap (LNT), a diesel oxidation catalyst (DOC), an ammonia oxidation catalyst (AMOX), a heat source for regeneration of the DPF, an exhaust gas recirculation (EGR) system, a muffler, and other similar devices. This document is directed to power systems equipped with NOx aftertreatment components, with or without additional components.

A NOx abatement catalyst module converts nitrogen NOx, with the aid of a catalyst, into diatomic nitrogen, N₂, and water, H₂O. A reductant, typically anhydrous ammonia, aqueous ammonia or urea, is injected upstream of the NOx abatement catalyst module so the reductant is adsorbed onto a catalyst of the SCR. Gaseous or liquid reductant may be injected into the exhaust stream. Liquid reductants are often referred to as diesel emission fluids (DEFs). DEF has become popular because of its liquid form, which is easy to store and handle. Further, DEF reduces the need to rely upon EGR to meet modern emission requirements.

Both SCR and LNT components may utilize platinum group metal (PGM) catalysts. As a result, exhaust after-treatment systems are sensitive to sulfur content in fuel because sulfur adsorbs onto and fouls PGM catalysts. Desulfation of a PGM catalyst requires permitting the exhaust gas to reach high temperatures (e.g., a catalyst bed temperature of about 650° C.) at a rich air/fuel ratio for an extended period, typically requiring at least several minutes of high-idle operation and an inconvenience to the operator. Desulfation occurs periodically, typically every 50 to 150 hours of engine operation, depending on the level of sulfur in the fuel, fuel consumption of the engine, and the NOx storage capacity of the PGM catalyst. Further, the use of PGM catalysts typically requires the use of ultra-low sulfur diesel (ULSD) fuel having a sulfur concentration of 15 ppm or less as opposed to low sulfur diesel (LSD) fuel having a sulfur concentration of 500 ppm or less in order to extend the time period between desulfation events. The inadvertent use of LSD fuel will quickly reduce the NOx reducing ability of a PGM catalyst.

Thus, when the sulfur content in the fuel is higher than expected, such as when LSD is erroneously added to the fuel tank instead of ULSD, time-based regenerations are inadequate and the NOx reducing performance of the exhaust after-treatment system is quickly reduced. While systems and methods for monitoring the performance of exhaust after-treatment systems may be useful for maintaining the performance of the exhaust after-treatment system, such monitoring systems do not identify why the after-treatment system is performing in a substandard fashion. Further, if an operator mistakenly uses LSD fuel, more frequent desulfations of the PGM catalyst must be carried out, which leads to frustration over increased fuel consumption and reduced available utilization time corresponding to the time it takes to regenerate the PGM catalyst.

US Patent Publication No. 2011/0271569 discloses a sensor for detecting sulfur in an exhaust stream that is positioned upstream of an exhaust after-treatment system. However, US Patent Publication No. 2011/0271569 does not disclose a means for a real-time detection of whether the sulfur content of the fuel is fouling an SCR catalyst.

Thus, there is a need for an exhaust aftertreatment control system that can quickly identify if a reduced NOx abatement performance of an exhaust aftertreatment system is being caused by the sulfur content of the fuel or if the reduced NOx abatement performance has an alternative cause, such as an equipment malfunction.

### SUMMARY

In one aspect, this document discloses a method for detecting if a fuel containing more than a sulfur concentration threshold value is being combusted in an engine. The engine may include a selective catalytic reduction (SCR) module. The disclosed method may include desulfating the NOx abatement catalyst module and detecting a proper functioning of the NOx abatement catalyst module. The detecting of the proper functioning of the NOx abatement catalyst module may be carried out by at least one of the following: detecting a NOx conversion ratio that is above a NOx conversion ratio threshold value; and detecting an ammonia slip value downstream of the NOx abatement catalyst module that is below an ammonia slip threshold value. The method may further include detecting a malfunction of the NOx abatement catalyst module by at least one of the following: detecting that the NOx conversion ratio is below the NOx conversion ratio threshold value; and detecting that the ammonia slip value downstream of the NOx abatement catalyst module is above the ammonia slip threshold value. The method may further include determining a first operating time of the engine between the desulfating and the detecting of the malfunction. If the first operating time is less than a predetermined maximum time and greater than a predetermined minimum time, the method may include increasing a frequent desulfation counter by 1. Further, the method may include sending a fault signal indicating that the sulfur concentration of the fuel exceeds the sulfur concentration threshold value concentration when the frequent desulfation counter exceeds a FDC threshold value.

In another aspect, this document discloses a system for detecting when an engine is combusting fuel containing more than a sulfur concentration threshold value. The system may include a selective catalytic reduction (SCR) module that includes an SCR catalyst. The system may further include at least one sensor for detecting at least one of the following: a NOx concentration downstream of the NOx abatement catalyst module; and a NH₃ concentration downstream of the NOx abatement catalyst module. The at least one sensor may be linked to a controller. The controller may be configured to calculate at least one of a conversion ratio of NOx by the NOx abatement catalyst module and a degree of ammonia slip. The controller may further be configured to initiate desulfation of the SCR catalyst if at least one of the conversion ratio or the degree of ammonia slip fails to meet at least one predetermined criteria. The controller may further be configured to record when a desulfation is complete and the controller may further be configured to determine a desulfation request time (DRT) between completion of a desulfation and initiation of a new desulfation. The controller may further be configured to increment a frequent desulfation counter (FDC) each time the DRT is greater than a predetermined minimum time and less than a predetermined maximum time. The controller may further be configured to initiate a sulfur alarm signal when the FDC reaches a NOx conversion ratio threshold value.

This document also discloses a power system. The disclosed power system may include an engine that includes a manifold exhaust passage in communication with a selective catalytic reduction (SCR) module that includes an SCR catalyst. The NOx abatement catalyst module may be in communication with an exhaust outlet. The power system may further include at least one sensor for detecting at least one of the following: a NOx concentration downstream of the NOx abatement catalyst module; and a NH₃ concentration downstream of the NOx abatement catalyst module. The at least one sensor may be linked to a controller. The controller may be configured to calculate at least one of a conversion ratio of NOx by the NOx abatement catalyst module and a degree of ammonia slip. The controller may be further configured to initiate desulfation of the SCR catalyst if at least one of the conversion ratio or the degree of ammonia slip fails to meet at least one of a predetermined criteria. The controller may further be configured to record when a desulfation is complete. The controller may further be configured to determine a desulfation request time (DRT) between completion of a desulfation and initiation of a new desulfation. The controller may further be configured to increment a frequent desulfation counter (FDC) each time the DRT is greater than a predetermined minimum time period and less than a predetermined maximum time period. The controller may further be configured to initiate a sulfur alarm signal when the FDC reaches a NOx conversion ratio threshold value.

The features, functions, and advantages discussed above may be achieved independently in various embodiments or may be combined in yet other embodiments, further details of which can be seen with reference to the following description and drawings.

### BRIEF DESCRIPTION OF THE DRAWINGS

For a more complete understanding of the disclosed methods and apparatuses, reference should be made to the embodiments illustrated in greater detail on the accompanying drawings, wherein:

FIG. 1 is a schematic and diagrammatic illustration of an exemplary disclosed power system.

FIG. 2 is a time line that schematically illustrates the desulfation request timer (DRT), the frequent slip timer (FST) and the frequent desulfation timer (FDT).

FIG. 3 is a flow chart illustrating the action of a controller when the desulfation request timer (DRT) exceeds a predetermined maximum time period.

FIG. 4 is a flow chart illustrating the indexing of the frequent desulfation counter (FDC) and the infrequent desulfation counter (IDC).

FIG. 5 is a flow chart illustrating the disclosed system and method for determining whether the sulfur concentration in the fuel being combusted is causing the decreased conversion ratio or ammonia slip failure or whether a component malfunction is causing the failure.

The drawings are not necessarily to scale and illustrate the disclosed embodiments diagrammatically and in partial views. In certain instances, this disclosure may omit details which are not necessary for an understanding of the disclosed methods and apparatuses or which render other details difficult to perceive. Further, this disclosure is not limited to the particular embodiments illustrated herein.

### DETAILED DESCRIPTION

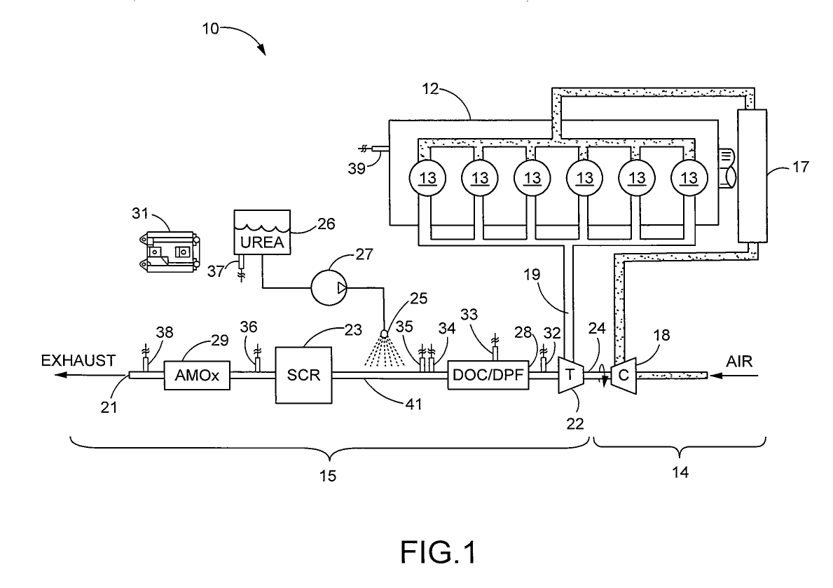

FIG. 1 illustrates an exemplary power system 10. For the purposes of this disclosure, the power system 10 is depicted and described as a diesel-fueled, internal combustion engine. However, it is contemplated that the power system 10 may embody any other type of combustion engine, such as, for example, a gasoline or a gaseous fuel-powered engine burning compressed or liquefied nature gas, propane, etc. The power system 10 may include an engine block 12 that may at least partially define a plurality of cylinders 13, and a plurality of piston assemblies (not shown) disposed within the cylinders 13. It is contemplated that power system 10 may include any number of cylinders 13 and that the cylinders 13 may be disposed in an “in-line” configuration, a “V” configuration, or any other conventional configuration.

Multiple separate sub-systems may be included within the power system 10. For example, the power system 10 may include an air induction system 14 and an exhaust system 15. The air induction system 14 may direct air or an air and fuel mixture into the power system 10 for subsequent combustion. The exhaust system 15 may exhaust the byproducts of combustion to the atmosphere. The operation of air induction and exhaust systems 14, 15 may be controlled to reduce the production of regulated constituents and their discharge to the atmosphere.

The air induction system 14 may include multiple components that cooperate to condition and introduce compressed air into the cylinders 13. For example, the air induction system 14 may include an air cooler 17 located downstream of a compressor 18, although a plurality of compressors may be employed. The compressor 18 may connect to pressurize inlet air directed through the air cooler 17. A throttle valve (not shown) may be located upstream of the compressor 18 to selectively regulate (i.e., restrict) the flow of inlet air into power system 10. A restriction may result in less air entering the power system 10 and, thus, affect an air-to-fuel ratio of power system 10. It is contemplated that the air induction system 14 may include different or additional components than described above such as, for example, variable valve actuators associated with each cylinder 13, filtering components, compressor bypass components, and other known components that may be controlled to affect the air-to-fuel ratio of power system 10. It is further contemplated that the compressor 18 and/or the air cooler 17 may be omitted, if the power system 10 is naturally aspirated.

The exhaust system 15 may include multiple components that condition and direct exhaust from the cylinders 13 to the atmosphere. For example, the exhaust system 15 may include an exhaust manifold conduit 19, an exhaust outlet 21 and a turbine 22. Although a single turbine 22 is shown in FIG. 1 for purposes of clarity, a plurality of turbines may be employed. The turbine 22 is driven by the exhaust flowing through exhaust manifold conduit 19. The exhaust system 15 may further include a NOx abatement catalyst module 23 fluidly connected downstream of the turbine 22. The NOx abatement catalyst module 23 may be a SCR module or another catalyst module capable of reducing NOx in the exhaust, as will be apparent to those skilled in the art. The exhaust system 15 may further include different or additional components than described above such as bypass components, an exhaust compression or restriction brake, a sound attenuation device, additional exhaust treatment devices, and other known components.

The turbine 22 may be located to receive exhaust leaving the engine block 12, and may connect to the compressor 18 of the air induction system 14 by way of a common shaft 24 to form a turbocharger. As the hot exhaust gases exit the power system 10 and move through the turbine 22 and expand against the vanes (not shown) thereof, the turbine 22 may rotate and drive the connected compressor 18 to pressurize the inlet air. In one embodiment, the turbine 22 may be a variable geometry turbine (VGT) or include a combination of variable and fixed geometry turbines.

The NOx abatement catalyst module 23 may receive exhaust from the turbine 22 and reduce constituents of the exhaust to innocuous gases. In one example, the NOx abatement catalyst module 23 may include a catalyst substrate (not shown) located downstream from a reductant injector 25. A gaseous or liquid reductant, most commonly urea ((NH₂)₂CO), a water/urea mixture, a hydrocarbon for example diesel fuel, or ammonia gas (NH₃), may be sprayed or otherwise advanced into the exhaust upstream of the NOx abatement catalyst module 23 by the reductant injector 25. For this purpose, an onboard reductant supply 26 and a pressurizing device or a pump 27 may be associated with the reductant injector 25. As the reductant is adsorbed onto the surface of catalyst substrate (not shown) of the NOx abatement catalyst module 23, the reductant may react with NOx (NO, NO₂, and NO₃) in the exhaust stream to form water (H₂O) and elemental nitrogen (N₂). The reduction process performed in the NOx abatement catalyst module 23 may be most effective when a ratio of NO to NO₂ supplied to the NOx abatement catalyst module 23 is adjusted to optimize the NOx reduction at the catalyst.

To help provide a more optimal concentration of NO to NO₂ at the NOx abatement catalyst module 23, an oxidation catalyst, such as a diesel oxidation catalyst (DOC) may be located upstream of the NOx abatement catalyst module 23, and in some embodiments, in the form of an optional combined diesel oxidation catalyst/diesel particulate filter (DOC/DPF) module 28. The oxidation catalyst may include a porous ceramic honeycomb structure or a metal mesh substrate coated with a material, such as a precious metal that catalyzes a chemical reaction to alter the composition of the exhaust. For example, the oxidation catalyst may include palladium, platinum, vanadium, or a mixture thereof that facilitates the conversion of NO to NO₂.

During operation of the power system 10, it may be possible for too much urea or too much ammonia to be injected into the exhaust (i.e., urea or ammonia in excess of that required for appropriate NOx reduction). In this situation, known as “ammonia slip,” some amount of ammonia may pass through the NOx abatement catalyst module 23 to the atmosphere, if not otherwise accounted for. To minimize the magnitude of ammonia slip, an ammonia oxidation (AMOx) module 29 may optionally be located downstream of the NOx abatement catalyst module 23. The AMOx module 29 may include a substrate coated with a catalyst that oxidizes residual NH₃ in the exhaust to form water and elemental nitrogen (N₂).

The power system 10 may include components configured to regulate the treatment of the exhaust prior to its discharge to the atmosphere. Specifically, the power system 10 may include a controller 31 in communication with a plurality of sensors 32-39 (the communication lines are not shown in FIG. 1 for purposes of clarity). The controller 31 may also be in communication with the pump 27. Based on inputs from the sensors 32-39, the controller 31 may determine an amount of NOx being produced by power system 10, an operational parameter of the NOx abatement catalyst module 23 and an optimal amount of urea to be sprayed by the reductant injector 25 into the exhaust passageway 41 based on the NOx production amount and the operational parameter. Using the sensors 32-39, the controller 31 may also determine a performance parameter of the NOx abatement catalyst module 23 and an adjustment of the urea injection based on the performance parameter. The controller 31 may then regulate operation of the reductant injector 25 and the pump 27 such that the adjusted amount of urea is sprayed into the exhaust flow upstream of the NOx abatement catalyst module 23.

The controller 31 may embody a single or multiple microprocessors, field programmable gate arrays (FPGAs), digital signal processors (DSPs), etc. that include a means for controlling an operation of power system 10 in response to signals received from the various sensors. Numerous commercially available microprocessors may perform the functions of the controller 31. The controller 31 may embody a microprocessor separate from that controlling other non-exhaust related power system functions, or the controller 31 may be integral with a general power system microprocessor and be capable of controlling numerous power system functions and modes of operation. If separate from the general power system microprocessor, the controller 31 may communicate with the general power system microprocessor via datalinks or other methods. Various other known circuits may be associated with the controller 31, including power supply circuitry, signal-conditioning circuitry, actuator driver circuitry (i.e., circuitry powering solenoids, motors, or piezo actuators), communication circuitry, and other appropriate circuitry.

A first sensor 32 of the power system 10 may be a constituent sensor configured to generate a signal indicative of the presence of a particular constituent within the exhaust flow. For example, the sensor 32 may be an engine-out NOx sensor configured to determine an amount (i.e., quantity, relative percent, ratio, etc.) of NO and/or NO₂ present within the exhaust of the power system 10. If embodied as a physical sensor, the engine-out NOx sensor 32 may be located upstream or downstream of the optional DOC/DPF module 28. Whether located upstream or downstream of the oxidation catalyst of the optional DOC/DPF module 28, the engine-out NOx sensor 32 may be situated to sense a production of NOx by the power system 10. The engine-out NOx sensor 32 may generate a signal indicative of these measurements and send the signal to the controller 31.

The engine-out NOx sensor 32 may alternatively embody a virtual sensor. A virtual sensor may produce a model-driven estimate based on one or more known or sensed operational parameters of the power system 10 and/or the optional DOC/DPF module 28. For example, based on a known operating speed, load, temperature, boost pressure, ambient conditions (humidity, pressure, temperature), and/or other parameters of the power system 10, a model may be referenced to determine an amount of NO and/or NO₂ produced by power system 10. Similarly, based on a known or estimated NOx production of the power system 10, a flow rate of exhaust exiting the power system 10, and/or a temperature of the exhaust, the model may be referenced to determine an amount of NO and/or NO₂ leaving the optional DOC/DPF module 28 and entering the NOx abatement catalyst module 23. As a result, the signal directed from engine-out NOx sensor 32 to the controller 31 may be based on calculated and/or estimated values rather than direct measurements. Rather than employing a separate element, virtual sensing functions may be accomplished by the controller 31.

The operational parameters of the NOx abatement catalyst module 23 may be monitored by way of the temperature sensor 34 and/or the flow meter sensor 35. The temperature sensor 34 may be located anywhere within exhaust system 15 to generate a signal indicative of an operating temperature of the NOx abatement catalyst module 23. In one example, the temperature sensor 34 may be located upstream of the NOx abatement catalyst module 23. In another example, the temperature sensor 34 may be located in contact with or downstream of the NOx abatement catalyst module 23. The flow meter sensor 35 may embody any type of sensor utilized to generate a signal indicative of an exhaust flow rate through the NOx abatement catalyst module 23. The temperature and/or flow rate signals may be utilized by the controller 31 to determine a NOx reducing capacity of the NOx abatement catalyst module 23. That is, based on known dimensions and the age of the catalyst of the NOx abatement catalyst module 23, and based on the measured operational parameters, a NOx reducing performance of the NOx abatement catalyst module 23 may be predicted. It is contemplated that the flow meter sensor 35 may alternatively embody a virtual sensor, similar to the engine-out NOx sensor 32.

Similar to the NOx abatement catalyst module 23, the operation of the optional DOC/DPF module 28 may be monitored by way of the temperature sensor 34 or another dedicated temperature sensor (not shown). The temperature signal may be utilized by the controller 31 to determine a model driven estimate of the ratio or split of NO:NO₂ exiting the optional DOC/DPF module 28.

Thus, a NOx production signal, a temperature signal, and a flow rate signal from sensors 32, 34, 35, may be utilized by the controller 31 to determine an optimal amount of reductant to be injected via the reductant injector 25 to reduce the produced NOx to a regulated level or less. The controller 31 may also subsequently adjust the injection amount based on actual performance parameters measured downstream of the NOx abatement catalyst module 23. That is, after an initial reductant injection of the quantity determined above, controller 31 may sense the actual performance of the NOx abatement catalyst module 23 and adjust future reductant injections accordingly. For this purpose, the power system 10 may include a post-aftertreatment NOx sensor 36 located downstream of the NOx abatement catalyst module 23. This process of adjusting the injection amount based on a measured performance parameter is known as feedback control.

Similar to the engine-out NOx sensor 32, the post-aftertreatment NOx sensor 36 may also generate a signal indicative of the presence of NOx within the exhaust flow. For instance, the post-aftertreatment NOx sensor 36 may determine an amount (i.e., quantity, relative percent, ratio, etc.) of NO and/or NO₂ present within the exhaust flow downstream of the NOx abatement catalyst module 23. The post-aftertreatment NOx sensor 36 may generate a signal indicative of these measurements and send it to the controller 31. If the amount of NOx monitored by the post-aftertreatment NOx sensor 36 exceeds a threshold level, the controller 31 may provide feedback to the reductant injector 25 to increase the amount of urea (or ammonia) injected into the exhaust passageway 41 to reduce NOx within the NOx abatement catalyst module 23. In contrast, if the amount of NOx monitored by the post-aftertreatment NOx sensor 36 is below a threshold level, less urea (or ammonia) may be injected in an attempt to conserve urea (or ammonia) and/or extend the useful life of oxidation catalyst within the AMOₓ module 29. Alternatively, the post-aftertreatment NOx sensor 36 may embody a sensor useful in determining the amount of NH₃ entering the AMOₓ module 29.

If the oxidation catalyst of the optional DOC/DPF module 28 is overloaded with particulate matter, the relative amount of NO₂ received by the NOx abatement catalyst module 23 could be negatively affected, even though the optional DOC/DPF module 28 may be properly converting NO to NO₂. To accommodate this situation, the soot loading of the oxidation catalyst of the optional DOC/DPF module 28 may be monitored, and the operation of the NOx abatement catalyst module 23 adjusted accordingly. For this purpose, an additional sensor 33 may be associated with oxidation catalyst of the optional DOC/DPF module 28. The sensor 33 may embody any type of sensor utilized to determine an amount of particulate buildup within an oxidation catalyst. For example, the sensor 33 may embody a pressure sensor or pair of pressure sensors, a temperature sensor, a model driven virtual sensor, an RF sensor, or any other type of sensor known in the art. The sensor 33 may generate a signal directed to the 31 indicative of a particulate buildup, and the controller 31 may adjust the injection of reductant through the reductant injector 25 accordingly.

The controller 31 may also adjust reductant injections based on an amount of urea available for injection. Thus, the power system 10 may include a sensor 37 associated with the reductant supply 26. The sensor 37 may be a temperature sensor, a viscosity sensor, a fluid level sensor, a pressure sensor, or any other type of sensor configured to generate a signal indicative of an amount of urea (or ammonia or reductant) available for injection. This signal may be directed from sensor 37 to the controller 31.

As noted above, in some situations, too much urea or reductant may be injected resulting in “ammonia slip.” Although the AMOₓ module 29, if present, may oxidize the slipping ammonia such that little, if any, ammonia is exhausted to the atmosphere, the extra ammonia may still unnecessarily increase the operational costs of the power system 10. For this reason, the controller 31 may adjust reductant injections based on a measured amount of ammonia downstream of the NOx abatement catalyst module 23 or upstream or downstream of the AMOₓ module 29. Ammonia slip may be monitored by a sensor 38, which may be a virtual sensor that generates an ammonia slip signal based on post processing of a signal generated by a true NOx sensor. Thus, the sensor 38 may be an NOx sensor that may be used to virtually detect ammonia slip.

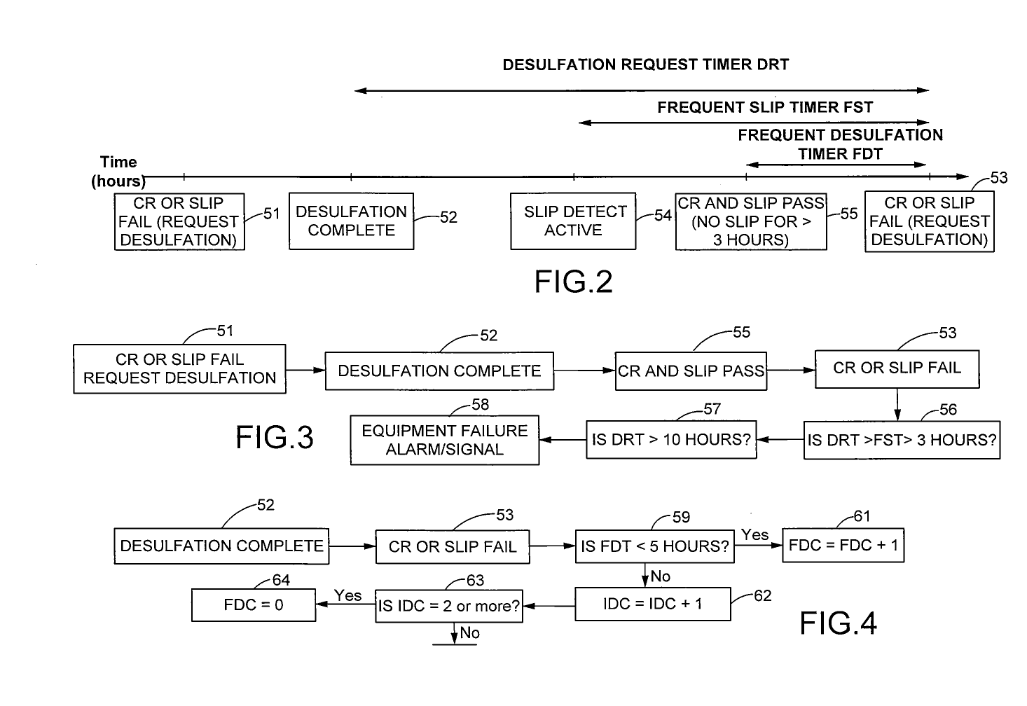

The interaction of the controller 31 with the sensors 32-38 is further illustrated in FIGS. 2-5. FIG. 2 is a timeline that illustrates certain times between events that are recorded and used by the controller 31 to determine whether fuel with a sulfur concentration above a threshold concentration (e.g., 15 ppm) is being combusted in the cylinders 13. At 51, the controller 31 has determined a failure in either: (1) a conversion ratio of the NOx (i.e., the concentration of NOx detected by the sensor 32 minus the concentration of NOx detected by the post-aftertreatment NOx sensor 36 divided by the concentration of NOx detected by the engine-out NOx sensor 32); or (2) a degree of ammonia slip detected by the sensor 38. If either the NOx conversion ratio falls below an NOx conversion ratio threshold value or the ammonia slip falls above an ammonia slip threshold value, the controller 31 registers a failure and initiates a request for desulfation of the catalyst of the NOx abatement catalyst module 23. Desulfation may be carried out in a variety of ways most of which include permitting the catalyst bed of the NOx abatement catalyst module 23 to reach an elevated temperature of about 550° C. When the desulfation is complete at 52, a desulfation request time or timer (DRT) is initiated as shown in FIG. 2. The DRT is the time between completion of a desulfation at 52 and a subsequent conversion ratio or slip failure and a request for a new desulfation at 53. Typically, if a fuel containing too much sulfur, such as LSD, is combusted in the power system 10, the time between a completed desulfation at 52 and a subsequent conversion ratio or ammonia slip failure at 53 will fall within a time range that is greater than about 3 hours and less than about 10 hours. Specifically, if the DRT, or the time between a completed desulfation at 52 and a subsequent conversion ratio or ammonia slip failure at 53, is less than 3 hours, it is evident that a component of the power system 10 is malfunctioning and the subsequent conversion ratio or ammonia slip failure at 53 is not caused by a sulfur buildup on the catalyst because it takes a minimum of about 3 hours for LSD to foul a properly desulfated catalyst. Thus, if DRT is less than 3 hours, a malfunction in the exhaust system 15 cannot be caused exclusively by LSD or a fuel with an excessive amount of sulfur. Similarly, if DRT exceeds 10 hours, excess sulfur in the fuel may be ruled out as the cause of the subsequent conversion ratio or slip failure at 53 because, if the power system 10 was burning LSD fuel, the conversion ratio or slip failure would occur before the duration of 10 hours, not after 10 hours has elapsed. Thus, for a conversion ratio or ammonia slip failure to be attributable to sulfur in the fuel, the DRT should fall within the 3 to 10 hour time range in this example. Of course, the lower and upper limits for the DRT may vary, as will be apparent to those skilled in the art.

Still referring to FIG. 2, if an ammonia slip sensor 38 (FIG. 1) is employed, the controller 31 may send a signal to activate or deactivate the ammonia slip sensor 38 as needed. As shown in FIG. 2, the time between an activation of the ammonia slip sensor 38 at 54 and the subsequent conversion ratio or slip failure at 53 is referred to as the frequent slip time or timer (FST). The FST must be greater than about 3 hours for sulfur in the fuel to cause the subsequent conversion ratio or ammonia slip failure at 53. If the FST is less than 3 hours, the problem is attributed to a component malfunction or a problem other than fouling of the catalyst of the NOx abatement catalyst module 23. Further, after a conversion ratio or slip failure at 51 and a subsequent desulfation at 52, the controller 31 continuously monitors data from the sensors 32, 36, 38. When a conversion ratio or ammonia slip measurement passes at 55 (i.e., the conversion ratio of NOx exceeds a threshold value and an ammonia slip value falls below a threshold value), the frequent desulfation timer (FDT) is initiated at 55. As shown in FIG. 2, FDT represents the time between a conversion ratio and ammonia slip pass at 55 and a subsequent conversion ratio or ammonia slip failure at 53. To register a conversion ratio and ammonia slip pass at 55, for the power system 10 shown in FIG. 1, both the data from the NOx sensors 32, 36 as well as the data from the ammonia slip sensor 38 must satisfy the threshold criteria. In other words, both NOx and ammonia slip (if both types of sensors are utilized) must pass at 55 while either the NOx conversion ratio or ammonia slip value can fail at 53 to register a failure.

FIG. 3 illustrates a situation where sulfur in the fuel is not causing a conversion ratio or ammonia slip failure. The controller 31 registers a conversion ratio or an ammonia slip failure at 51 (and requests desulfation) and the desulfation is complete at 52. Then, the controller 31 registers a conversion ratio and an ammonia slip pass at 55 followed by a failure at 53. If the DRT (desulfation request timer) and the FST (frequent slip timer) are both greater than 3 hours at 56 and the DRT is greater than 10 hours at 57, then the fouling problem that occurred at 53 is not attributable to sulfur in the fuel and, therefore an equipment failure or alarm signal is issued at 58. The equipment failure or alarm signal may be an audible tone or lamp in an operator cab or may be a flag readable as an error code on a diagnostic device among other potential signals.

Turning to FIG. 4, when the controller 31 determines that desulfation is complete at 52, a subsequent conversion ratio or slip failure occurs at 53, and the FDT (frequent desulfation timer) is less than 5 hours at 59, a frequent desulfation counter (FDC) is incremented by 1 at 61. If the FDT is not less than 5 hours or is greater than 5 hours at 59, then an infrequent desulfation counter is indexed by 1 at 62. Further, if the IDC (infrequent desulfation counter) is equal to 2 or more at 63, then the FDC is reset to 0 at 64.

It will be noted that the time periods discussed above in connection with FIGS. 2-4 may be varied, depending upon the size and structure of the NOx abatement catalyst module 23 and various parameters of the power system 10. For example, the threshold time period for the FDT (frequent desulfation timer) in order for the FDC (frequent desulfation counter) to be incremented may range from about 3 hours to about 7 hours as opposed to the 5 hours indicated in FIG. 4. Further, the requisite time period for the FST (frequent slip timer) in order for fouling to be attributable to fuel may vary from the 3 hours set forth in FIGS. 2-3 and may range from about 2 to about 4 hours. Further, in order for fouling to be attributable to fuel, the indicated range for the DRT (desulfation request timer) may vary from the stated 3-10 hour change. The lower end of this range should correspond that of the FST, and may vary from about 2 to about 4 hours and the upper range for the DRT may range from about 6 to about 15 hours, again depending upon the structure of the NOx abatement catalyst module, the particular power system 10, the particular catalyst utilized, and a host of other factors.

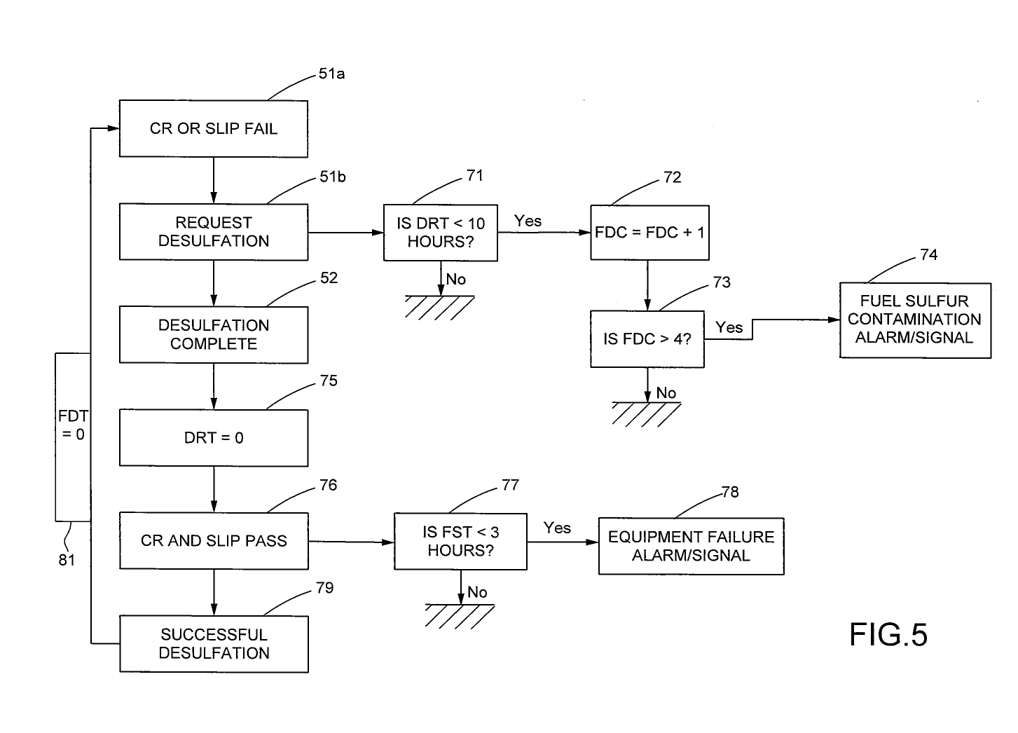

FIG. 5 explains the disclosed method and system for detecting when an engine is combusting fuel containing more than a threshold concentration of sulfur. A conversion ratio or ammonia slip failure is detected at 51a by the controller 31 based on signals from the sensors 32, 36, 38 and the controller 31 initiates a desulfation at 51b. The controller determines if the DRT (desulfation request timer) is less than 10 hours at 71 and, if the DRT is less than 10 hours at 71, the FDC (frequent desulfation counter) is incremented at 72. If the FDC exceeds 4 (or an alternative threshold value) at 73, the controller initiates a sulfur contamination alarm/signal at 74. After the desulfation is requested at 51b and the desulfation is complete at 52, the DRT (desulfation request timer) is reset to 0 at 75. If the controller 31 registers a conversion ratio or ammonia slip pass at 76, the controller 31 determines if the FST (frequent slip timer) is less than 3 hours at 77. If the FST is less than 3 hours at 77, the conversion ratio or ammonia slip failure at 51a is not due to sulfur in the fuel because, as discussed above in connection with FIG. 2, sulfur in the fuel takes more than 3 hours to foul the catalyst of the NOx abatement catalyst module 23. Thus, if the FST is less than 3 hours at 77, an equipment failure alarm/signal is initiated at 78, which indicates to the operator that the failure is not due to sulfur in the fuel. If the conversion ratio and ammonia slip passes at 76, the controller considers it a successful desulfation at 79 and the frequent desulfation timer is reset to 0 at 81.

Again, while FIG. 5 indicates specific values for threshold values, such as that for the DRT, FDC and FST, these values may vary, as will be apparent to those skilled in the art. Referring to block 71 of FIG. 5, the DRT is less than 10 hours, fuel is considered to be the problem and the FDC is incremented at 72. The 10-hour value for the DRT in block 71 may vary and may range from about 6 to about 15 hours, depending upon the specific NOx abatement catalyst module employed. Similarly, because conversion ratio and ammonia slip failures can result from noise or other problems with the power system 10, prior to the issuance of a fuel sulfur contamination alarm/signal at 74, the FDC must exceed 4 or, there must be at least 4 conversion ratio or ammonia slip failures prior to the issuance of a fuel sulfur contamination alarm/signal. Of course, the value of 4 for the FDC may vary and may range from as few as 2 to several or more. Similarly, as discussed above, the time required for sulfur and fuel to foul a catalyst is typically about 3 hours, but depending upon the NOx abatement catalyst module 23 utilized, the lower limit or the 3-hour limit for the FST may range from about 2 to about 4 hours.

### INDUSTRIAL APPLICABILITY

The method and system for detecting when an engine is combusting fuel containing more than a threshold concentration of sulfur may be applicable to any power system 10 having a reduction catalyst and which employs injection of a reductant into the exhaust upstream of the reduction catalyst. Referring to FIG. 1, the air induction system 14 may pressurize and force air or a mixture of air and fuel into the cylinders 13 for combustion. The fuel and air mixture may combust to produce mechanical work and an exhaust flow of hot gases through the exhaust manifold conduit 19. The exhaust flow may contain a complex mixture of air pollutants composed of gassiest material, which can include oxides of nitrogen (NOx). Following the optional DOC/DPF module 28 shown in FIG. 1, the exhaust flow may be directed towards the reduction catalyst of the NOx abatement catalyst module 23, where the NOx may be reduced to water and elemental nitrogen.

Prior to reaching the reduction catalyst of the NOx abatement catalyst module 23, the controller 31 may, based on input from the NOx sensors 32, 36, determine an amount of reductant required for the NOx abatement catalyst module 23 to sufficiently reduce the NOx produced by the power system 10. The amount of reductant injected by the reductant injector 25 may be adjusted, based on input from the sensors 33, 37, 38, and/or 39. After reduction takes place within the NOx abatement catalyst module 23, the exhaust may pass through the AMOₓ module 29 to the atmosphere. Within the AMOₓ module 29, any additional ammonia may be reduced to innocuous substances, unless the catalyst of the NOx abatement catalyst module 23 is fouled.

To determine if the catalyst of the NOx abatement catalyst module is fouled, various time periods are kept track of. Specifically, if the time period between a conversion ratio and an ammonia slip pass and subsequent conversion ratio or ammonia slip failure (see the blocks 55 and 53 of FIG. 2) is less than 3 hours or the FDT is less than 3 hours, the failure is deemed to be not attributable to sulfur in the fuel. This is because it typically takes more than a threshold value of time to foul the catalyst of the NOx abatement catalyst module 23. In the example set forth above, this threshold time value is about 3 hours. However, this time value may vary and, in order for a conversion ratio or a slip failure to be attributable to sulfur in the fuel, the time between a previous pass (see the block 55 of FIG. 2) and a subsequent failure (see the block 53 of FIG. 2) must be more than a threshold time value. This threshold time value may be about 3 hours, but may range from about 2 to about 4 hours. Further, if an ammonia slip sensor 38 is utilized, a FST (frequent slip timer) is also utilized. In the examples set forth above, when the FST is less than 3 hours, a conversion ratio or slip failure is attributed to equipment failure, and not sulfur in the fuel as shown in FIG. 5 (see blocks 77 and 78). This 3-hour threshold value may vary, of course, and may range from about 2 to about 4 hours. Still further, the time between a completed desulfation (see block 52 of FIG. 2) and a subsequent conversion ratio or ammonia slip failure (see block 53 of FIG. 2) is deemed the DRT (desulfation request timer). In order for a failure to be attributable to sulfur in the fuel, the DRT should exceed the time limit for the FST (e.g., 3 hours or a range from about 2 to about 4 hours) and the DRT must not exceed a certain time period as well. In the example set forth above, if the DRT exceeds 10 hours, (see block 71 of FIG. 5), the FDC is not incremented and a sulfur contamination alarm/signal is not generated. This is because if fuel having too much sulfur is being combusted in the power system 10, a conversion ratio or slip failure will be registered by the controller 31 within a certain time period, which may be about 10 hours or less. The 10-hour threshold value may be modified and may range from about 6 to about 15 hours, depending upon the NOx abatement catalyst module 23 utilized, the details of the power system 10 and other factors as well. Thus, the 10-hour example shown in FIGS. 3 and 5 is but an example, as will be apparent to those skilled in the art.

Alternative embodiments and various modifications will be apparent from the above description to those skilled in the art. These and other alternatives are considered equivalents and within the spirit and scope of the present disclosure.

1. A method for detecting if a fuel containing more than a sulfur concentration threshold value is being combusted in an engine, the engine including a NOx abatement catalyst module, the method comprising:
desulfating the NOx abatement catalyst module;
detecting a proper functioning of the NOx abatement catalyst module by at least one of
detecting a NOx conversion ratio that is above a NOx conversion ratio threshold value and
detecting an ammonia slip value downstream of the NOx abatement catalyst module that is below an ammonia slip threshold value;
detecting a malfunction of the NOx abatement catalyst module by at least one of
detecting that the NOx conversion ratio is below the NOx conversion ratio threshold value and
detecting that the ammonia slip value downstream of the NOx abatement catalyst module is above the ammonia slip threshold value;
determining a first operating time of the engine between the desulfating and the detecting of the malfunction, and if the first operating time is less than a predetermined maximum time and greater than predetermined minimum time, increasing a frequent desulfation counter (FDC) by 1; and
when the FDC exceeds a FDC threshold value, sending a fault signal indicating that a sulfur concentration of the fuel exceeds the sulfur concentration threshold value.

2. The method of claim 1 further comprising determining a second operating time of the engine between the desulfating and the detecting of the malfunction, and if the second operating time is less than the predetermined minimum time, sending a fault signal indicating an equipment failure.

3. The method of claim 1 further comprising determining a second operating time of the engine between the desulfating and the detecting of the malfunction, and if the second operating time is more than the predetermined maximum time, sending a fault signal indicating an equipment failure.

4. The method of claim 1 wherein the predetermined minimum time is about 3 hours.

5. The method of claim 1 wherein the predetermined maximum time is about 10 hours.

6. The method of claim 1 wherein the FDC threshold value is at least 2.

7. The method of claim 1 wherein the FDC threshold value is 4.

8. The method of claim 1 wherein the sulfur concentration threshold value is about 15 ppm.

9. The method of claim 1 wherein the detecting of ammonia slip is carried out by a virtual ammonia sensor.

10. The method of claim 9 further including deactivating the virtual ammonia sensor prior to desulfating the NOx abatement catalyst module and activating the virtual ammonia sensor after desulfating the NOx abatement catalyst module, the method further including recording a frequent slip time between activating the virtual ammonia sensor and a subsequent desulfation, and if the frequent slip time is less than the predetermined minimum time, sending a fault signal indicating an equipment failure.

11. The method of claim 1 wherein the detecting of NOx conversion is carried out by an engine-out NOx sensor disposed upstream of the NOx abatement catalyst module and a post-aftertreatment NOx sensor disposed downstream of the NOx abatement catalyst module.

12. The method of claim 1 wherein if the first operating time is greater than 5 hours, increasing an infrequent desulfation counter (IDC) by 1;
when the IDC exceeds an IDC threshold value, resetting the FDC to 0.

13. The method of claim 12 wherein the IDC threshold value is 2.

14. A system for detecting when an engine is combusting fuel containing more than a sulfur concentration threshold value, the system comprising:
a selective catalytic reduction (SCR) module including an SCR catalyst;
at least one sensor for detecting at least one of
a NOx concentration downstream of a NOx abatement catalyst module and
a NH₃ concentration downstream of the NOx abatement catalyst module,
the at least one sensor linked to a controller;
the controller configured to calculate at least one of a NOx conversion ratio by the NOx abatement catalyst module and a degree of ammonia slip;
the controller further configured to initiate desulfation of the SCR catalyst if at least one of a conversion ratio or a degree of ammonia slip fails to meet at least one predetermined criteria;
the controller further configured to record when a desulfation is complete;
the controller configured to determine a desulfation request time (DRT) between completion of a desulfation and initiation of a new desulfation;
the controller configured to increment a frequent desulfation counter (FDC) each time the DRT is greater than a predetermined minimum time and less than a predetermined maximum time;
the controller configured to initiate a fuel sulfur alarm signal when the FDC reaches a NOx conversion ratio threshold value.

15. The system of claim 14 wherein the predetermined minimum time is about 3 hours.

16. The system of claim 14 wherein the predetermined maximum time is about 10 hours.

17. The system of claim 14 wherein the NOx conversion ratio threshold value is greater than 2.

18. The system of claim 17 wherein the NOx conversion ratio threshold value is 4.

19. The system of claim 14 wherein the controller is further configured to generate an equipment failure signal if the DRT is less than 3 hours.

20. The system of claim 14 wherein the controller is further configured to generate an equipment failure signal if the DRT is more than 10 hours.

21. The system of claim 14 wherein the sulfur concentration threshold value is about 15 ppm.

22. The system of claim 14 wherein the at least one sensor is an ammonia sensor is a virtual sensor.

23. The system of claim 14 wherein the at least one sensor is an engine-out NOx sensor disposed upstream of the NOx abatement catalyst module and a post-aftertreatment NOx sensor disposed downstream of the NOx abatement catalyst module.

24. A power system comprising:
an engine including a manifold exhaust passage in communication with a selective catalytic reduction (SCR) module including an SCR catalyst, the NOx abatement catalyst module in communication with an exhaust outlet;
at least one sensor for detecting at least one of
a NOx concentration downstream of the NOx abatement catalyst module and
a NH₃ concentration downstream of the NOx abatement catalyst module,
the at least one sensor linked to a controller,
the controller configured to calculate at least one of a NOx conversion ratio by the NOx abatement catalyst module and a degree of ammonia slip;
the controller further configured to initiate desulfation of the SCR catalyst if at least one of the conversion ratio or the degree of ammonia slip fails to meet at least one predetermined criteria;
the controller further configured to record when a desulfation is complete;
the controller configured to determine a desulfation request time (DRT) between completion of a desulfation and initiation of a new desulfation;
the controller configured to increment a frequent desulfation counter (FDC) each time the DRT is greater than a predetermined minimum time and less than a predetermined maximum time;
the controller configured to initiate a fuel sulfur alarm signal when the FDC reaches a NOx conversion ratio threshold value; and
the controller further configured to generate an equipment failure signal if the DRT is more than the predetermined maximum time.
